(19) United States
(12) Patent Application Publication
(10) Pub. No.: US 2025/0136877 A1
(43) Pub. Date: May 1, 2025

(54) PROCESS FOR HYDROPROCESSING A BIORENEWABLE FEEDSTOCK

(71) Applicant: UOP LLC, Des Plaines, IL (US)

(72) Inventors: Neeraj Tiwari, Gurgaon (IN); Eseoghene Jeroro, Chicago, IL (US); James T. Wexler, Wheaton, IL (US); Sean Mann, Chicago, IL (US); Zubia Akmal Khan, Gurgaon (IN)

(21) Appl. No.: 18/791,423

(22) Filed: Jul. 31, 2024

Related U.S. Application Data
(60) Provisional application No. 63/594,943, filed on Oct. 31, 2023.

(51) Int. Cl. C10G 65/12

(52) U.S. Cl. CPC C10G 65/12; C10G 2300/1003; C10G 2300/1007; C10G 2300/1014; C10G 2300/1018

(57) ABSTRACT

A process and apparatus for producing biofuel from biorenewable feedstock is disclosed. The process comprises hydrotreating the biorenewable feed stream in a hydrotreating reactor to hydrodeoxygenate a biorenewable feed stream to provide a hydrotreated effluent stream. The hydrotreated effluent stream is separated in a hot separator into a hot separated vapor stream and a hot separated liquid stream. A hydroisomerization feed stream is taken from the hot separated liquid stream and hydroisomerized in a hydroisomerization reactor to provide a hydroisomerized stream. All or a portion of a return stream taken from the hot separated vapor stream is recycled to the hydroisomerization reactor. The disclosed process and apparatus minimize the carryover of the normal C16 to the biofuel and maximizes the hydroisomerization of n-paraffin hydrocarbons in the hydrotreated effluent stream to produce a biofuel which meets the biofuel specification without affecting or compromising the biofuel yield.

### FIELD

The field is related to a process and apparatus for producing biofuel from biorenewable feedstock. The field may particularly relate to a process and apparatus for producing jet fuel.

### BACKGROUND

As the demand for fuel increases worldwide, there is increasing interest in producing fuels and blending components from sources other than crude oil. Often referred to as a biorenewable source, these sources include, but are not limited to, plant oils such as corn, rapeseed, canola, soybean, microbial oils such as algal oils, animal fats such as inedible tallow, fish oils and various waste streams such as yellow and brown greases and sewage sludge. A common feature of these sources is that they are composed of glycerides and free fatty acids (FFA). Both triglycerides and the FFAs contain aliphatic carbon chains having from about 8 to about 24 carbon atoms. The aliphatic carbon chains in triglycerides or FFAs can be fully saturated or mono, di or poly-unsaturated.

Hydroprocessing can include processes which convert hydrocarbons in the presence of hydroprocessing catalyst and hydrogen to more valuable products. Hydrotreating is a process in which hydrogen is contacted with hydrocarbons in the presence of hydrotreating catalysts which are primarily active for the removal of heteroatoms, such as sulfur, nitrogen, oxygen and metals from the hydrocarbon feedstock. In hydrotreating, hydrocarbons with double and triple bonds such as olefins may be saturated.

The production of hydrocarbon products in the diesel boiling range can be achieved by hydrotreating a biorenewable feedstock. A biorenewable feedstock can be hydroprocessed by hydrotreating to deoxygenate, including decarboxylate and decarbonylate, the oxygenated hydrocarbons. Hydrotreating may be followed by hydroisomerization to improve cold flow properties of product diesel and jet fuel. Hydroisomerization or hydrodewaxing is a hydroprocessing process that increases the alkyl branching on a hydrocarbon backbone in the presence of hydrogen and hydroisomerization catalyst to improve cold flow properties of the hydrocarbon. Hydroisomerization includes hydrodewaxing herein.

Hydrocracking is a hydroprocessing process in which hydrocarbons crack in the presence of hydrogen and hydrocracking catalyst to lower molecular weight hydrocarbons. Depending on the desired output, a hydrocracking unit may contain one or more beds of the same or different catalyst.

When producing jet fuel from triglycerides (also referred to as “fats”) a certain degree of hydrocracking and hydroisomerization is needed to meet the specifications of jet fuel as outlined in ASTM D7566 Annex 2 and ASTM D1655. These key specifications that are required of the jet fuel in D7566 are freeze point of no higher than −40° C. (ASTM D5972, D7153 or D7154), density of no more than 772 kg/m³ (ASTM D1298 or D4052), T10 of less than 205° C. (ASTM D86), and a final boiling point (FBP) of less than 300° C. (ASTM D86). Larger molecules that do not meet these jet fuel specifications are hydrocracked primarily to meet these specifications which inherently results in low yield in the production process and in a low energy

Molecules in jet fuel usually range from hydrocarbons containing 8 carbon atoms (C8) to those containing 16 carbon atoms (C16). A higher concentration of heavier molecules such as C16 hydrocarbons can affect the freeze point of the jet fuel. Sometimes, refiners resort to operating the hydroisomerization reactor at a higher severity to meet the jet fuel freeze point of about −47° C. (−52.6° F.). But, due to higher severity of the hydroisomerization reactor, there may be a jet fuel yield loss of about 1 w % to about 1.5 wt %.

As refiners seek to add capability for processing biorenewable feedstocks, processes are sought to produce greater volumes of jet fuel due to its high value and demand. Processes for producing diesel and increased yield of jet fuel from biorenewable feedstocks are desired.

### SUMMARY OF THE INVENTION

The process produces biofuel from a biorenewable feedstock by hydrotreating a biorenewable feed stream to remove heteroatoms and hydroisomerizing it to improve cold flow properties. We have found carryover of C16 hydrocarbons to the biofuel affects fuel specifications, particularly the freeze point. The disclosed process produces jet fuel range material which meets the jet fuel specification without affecting or compromising the jet fuel yield. The disclosed process and apparatus separate a hydrotreated hot separator vapor stream into a liquid stream that is at least in part routed to the hydroisomerization reactor. Normal C16 hydrocarbons in the hot separator vapor are redirected to hydroisomerization to addresses nC16 carryover so that no yield detriment is taken in the biofuel product stream meeting the fuel freeze point specification.

### BRIEF DESCRIPTION OF THE DRAWINGS

FIG. 1 is a simplified process flow diagram of the process for producing biofuel from biorenewable feedstock in accordance with an exemplary embodiment of the present disclosure.

FIG. 2 is a simplified process flow diagram of the process for producing biofuel from biorenewable feedstock in accordance with another exemplary embodiment of the present disclosure.

FIG. 3 is a simplified process flow diagram of the process for producing biofuel from biorenewable feedstock in accordance with yet another exemplary embodiment of the present disclosure.

FIG. 4 is a simplified process flow diagram of the process for producing biofuel from biorenewable feedstock in accordance with still another exemplary embodiment of the present disclosure.

### DEFINITIONS

The term “communication” means that material flow is operatively permitted between enumerated components.

The term “downstream communication” means that at least a portion of material flowing to the subject in downstream communication may operatively flow from the object with which it communicates.

The term “upstream communication” means that at least a portion of the material flowing from the subject in upstream communication may operatively flow to the object with which it communicates.

The term “direct communication” means that flow from the upstream component enters the downstream component without passing through a fractionation or conversion unit to undergo a compositional change due to physical fractionation or chemical conversion.

The term “indirect communication” means that flow from the upstream component enters the downstream component after passing through a fractionation or conversion unit to undergo a compositional change due to physical fractionation or chemical conversion.

The term “bypass” means that the object is out of downstream communication with a bypassing subject at least to the extent of bypassing.

The term “column” means a distillation column or columns for separating one or more components of different volatilities. Unless otherwise indicated, each column includes a condenser on an overhead of the column to condense and reflux a portion of an overhead stream back to the top of the column and a reboiler at a bottom of the column to vaporize and send a portion of a bottoms stream back to the bottom of the column. Feeds to the columns may be preheated. The top pressure is the pressure of the overhead vapor at the vapor outlet of the column. The bottom temperature is the liquid bottom outlet temperature. Overhead lines and bottoms lines refer to the net lines from the column downstream of any reflux or reboil to the column. Stripper columns may omit a reboiler at a bottom of the column and instead provide heating requirements and separation impetus from a fluidized inert media such as steam. Stripping columns typically feed a top tray and take a main product from the bottom.

As used herein, the term “a component-rich stream” means that the rich stream coming out of a vessel has a greater concentration of the component than the feed to the vessel.

As used herein, the term “a component-lean stream” means that the lean stream coming out of a vessel has a smaller concentration of the component than the feed to the vessel.

As used herein, the term “boiling point temperature” means atmospheric equivalent boiling point (AEBP) as calculated from the observed boiling temperature and the distillation pressure, as calculated using the equations furnished in ASTM D86 or ASTM D2887.

As used herein, the term “True Boiling Point” (TBP) means a test method for determining the boiling point of a material which corresponds to ASTM D-2892 for the production of a liquefied gas, distillate fractions, and residuum of standardized quality on which analytical data can be obtained, and the determination of yields of the above fractions by both mass and volume from which a graph of temperature versus mass % distilled is produced using fifteen theoretical plates in a column with a 5:1 reflux ratio.

As used herein, the term “T5” or “T95” means the temperature at which 5 mass percent or 95 mass percent, as the case may be, respectively, of the sample boils using ASTM D-86 or TBP.

As used herein, the term “initial boiling point” (IBP) means the temperature at which the sample begins to boil using ASTM D2887, ASTM D-86 or TBP, as the case may be.

As used herein, the term “final boiling point” (FBP) means the temperature at which the sample has all boiled off using ASTM D2887, ASTM D-86 or TBP, as the case may be.

As used herein, the term “end point” (EP) means the temperature at which the sample has all boiled off using ASTM D2887, ASTM D-86 or TBP, as the case may be.

As used herein, the term “jet fuel range material” means hydrocarbons boiling in the range of an IBP between about 85° C. (185° F.) and about 135° C. (275° F.) or a T5 between about 110° C. (230° F.) and about 160° C. (320° F.) and the “recycle cut point” comprising a T95 between about 295° C. (563° F.) and about 315° C. (599° F.) using the TBP distillation method. Hydrocarbons beyond the “recycle cut point” and up to the “diesel cut point” comprising a T95 between about 343° C. (650° F.) and about 399° C. (750° F.) are the “diesel boiling range” material using the TBP distillation method.

As used herein, the term “conversion” means the ratio of product that boils below a recycle cut point to the feed that boils at or above the recycle cut point.

As used herein, the term “separator” means a vessel which has an inlet and at least an overhead vapor outlet and a bottoms liquid outlet and may also have an aqueous stream outlet from a boot. A flash drum is a type of separator which may be in downstream communication with a separator that may be operated at higher pressure.

As used herein, the term “predominant” or “predominate” means greater than 50%, suitably greater than 75% and preferably greater than 90%.

As used herein, the term “Cₓ” is to be understood to refer to molecules having the number of carbon atoms represented by the subscript “x”. Similarly, the term “Cₓ−” refers to molecules that contain less than or equal to x and preferably x and less carbon atoms. The term “Cₓ+” refers to molecules with more than or equal to x and preferably x and more carbon atoms.

As used herein, the term “carbon number” refers to the number of carbon atoms per hydrocarbon molecule and typically a paraffin molecule.

### DETAILED DESCRIPTION

With growing emphasis on environmental and sustainable economy, it has become more and more attractive for refiners to produce green fuels as part of their portfolio to maximize their profitability from Renewable Identification Numbers (RINs) credited under the Renewable Fuel Standard Program. RINs are credits used for compliance which can be traded within the program to increase profitability. The present disclosure enables refiners to produce a jet fuel which meets the jet fuel specification without compromising the jet fuel yield of the process.

Freeze point is one of the parameters to assess the safe operability of the sustainable aviation fuel (SAF) at lower temperature. SAF that meets the freeze point specification is desirable. So, producing SAF that meets the freeze point specification is important for its operability. Applicants observed that the nC16 carryover to the SAF affects the fuel freeze point. In case of lighter feed, nC16 carryover can be so high that even operating the hydroisomerization reactor at higher severity alone does not yield SAF that meets freeze point. A process and apparatus are disclosed that provides a solution that reduces nC16 carryover to minimum level and down to zero carryover so that yield is maintained or improved while meeting SAF freeze point requirements.

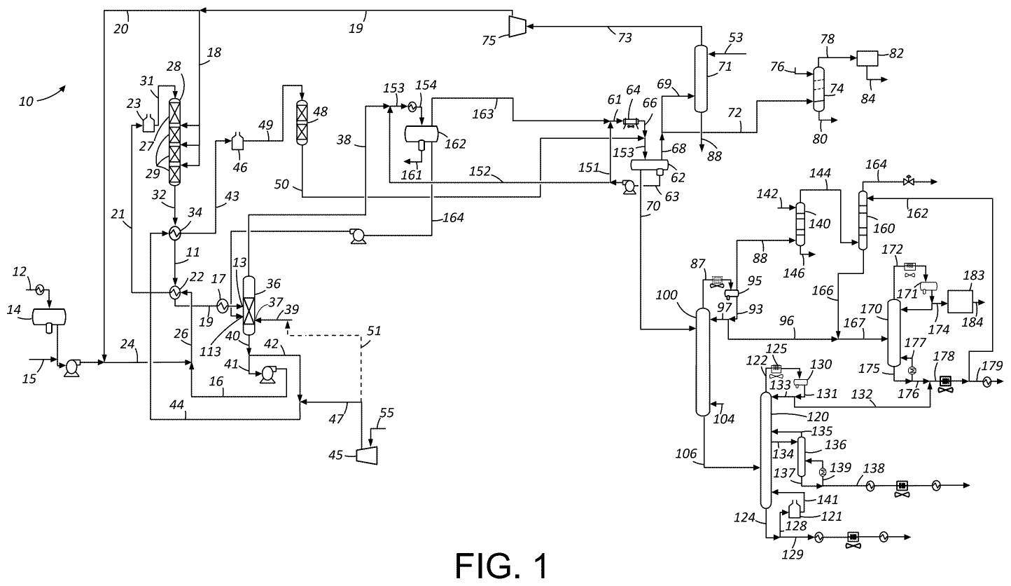

In FIG. 1, in accordance with an exemplary embodiment, a process 10 is shown for processing a hydrocarbon feedstock. Preferably, the hydrocarbon feedstock is a biorenewable hydrocarbon feedstock. A feed line 12 transports a hydrocarbon stream of fresh biorenewable feedstock into a feed surge drum 14. The biorenewable feedstock may be blended with a mineral feed stream but preferably comprises a predominance of or all biorenewable feedstocks. A mineral feedstock is a conventional feed derived from crude oil that is extracted from the ground. The biorenewable feedstock may comprise a nitrogen concentration of about 50 wppm to about 2000 wppm. The biorenewable feedstock may comprise high oxygen content which can be up to 10 wt % or higher.

A variety of different biorenewable feedstocks may be suitable for the process 10. The term “biorenewable feedstock” is meant to include feedstocks other than those obtained from crude oil. The biorenewable feedstock may include any of those feedstocks which comprise at least one of glycerides and free fatty acids. Most of glycerides will be triglycerides, but monoglycerides and diglycerides may be present and processed as well. Free fatty acids may be obtained from phospholipids which may source phosphorous in the feedstock. Examples of these biorenewable feedstocks include, but are not limited to, camelina oil, canola oil, corn oil, soy oil, rapeseed oil, soybean oil, colza oil, tall oil, sunflower oil, hempseed oil, olive oil, linseed oil, coconut oil, babassu oil, castor oil, peanut oil, palm oil, mustard oil, tallow, yellow and brown greases, lard, train oil, fats in milk, fish oil, algal oil, sewage sludge, and the like. Additional examples of biorenewable feedstocks include non-edible vegetable oils from the group comprising Jatropha curcas (Ratanjot, Wild Castor, Jangli Erandi), Madhuca indica (Mohuwa), Pongamia pinnata (Karanji, Honge), calophyllum inophyllum, moringa oleifera and Azadirachta indica (Neem). The triglycerides and FFAs of the typical vegetable or animal fat contain aliphatic hydrocarbon chains in their structure which have about 8 to about 30 carbon atoms. Biorenewable feedstocks may also include biomass pyrolysis oils and Fischer-Tropsch waxes. As will be appreciated, the biorenewable feedstock may comprise a mixture of one or more of the foregoing examples. The biorenewable feedstock may be pretreated to remove contaminants and filtered to remove solids.

The hydrocarbon stream in feed line 12 flows from the feed surge drum 14 via a charge pump perhaps after injection with a sulfiding agent in line 15 and mixes with a recycle hydrotreating hydrogen stream in a hydrotreating hydrogen line 20 to provide a combined hydrocarbon stream in line 24. The combined hydrocarbon stream in line 24 is mixed with a hydrotreating recycle stream in a recycle line 16 to provide a hydrotreating charge hydrocarbon stream in a hydrotreating charge line 26. The recycle to feed rate can be about 1:1 to about 5:1. The hydrotreating charge hydrocarbon stream in line 26 may be preheated in a combined feed exchanger 22 by heat exchange with a hydrotreated stream in a hydrotreated line 11 and perhaps then in a fired heater 23. The heated hydrotreating charge hydrocarbon stream in the hydrotreating charge line 31 may be then charged to a hydrotreating reactor 28.

The hydrotreating reactor 28 may include a guard bed reactor or a guard bed 27. In FIG. 1, the hydrotreating reactor 28 includes a guard bed 27. The guard bed reaction temperature may range between about 246° C. (475° F.) and about 343° C. (650° F.) and suitably between about 288° C. (550° F.) and about 304° C. (580° F.). Reaction temperature is operated low enough to prevent olefins in the FFA from polymerizing but high enough to foster olefin saturation, hydrodemetallation, hydrodeoxygenation, and hydrodenitrification reactions to occur. Hydrodeoxygenation reactions preferably minimize hydrodecarbonylation and hydrodecarboxylation reactions to preserve carbon atoms on the paraffin chain.

The guard bed 27 can comprise a base metal catalyst on a support. Base metals useable in this process include non-noble metals, nickel, chromium, molybdenum and tungsten. Other base metals that can be used include tin, indium, germanium, lead, cobalt, gallium and zinc. The process can also use a metal sulfide, wherein the metal in the metal sulfide is selected from one or more of the base metals listed. The hydrotreating charge stream can be charged through the base metal catalysts at pressures from 1379 kPa (abs) (200 psia) to 13790 kPa (abs) (2000 psia). In a further embodiment, the guard bed catalyst can comprise a second metal, wherein the second metal includes one or more of the metals: tin, indium, ruthenium, rhodium, rhenium, osmium, iridium, germanium, lead, cobalt, gallium, zinc and thallium. A nickel molybdenum on alumina catalyst may be a suitable catalyst in the guard bed 27. Although only one guard bed is shown in FIG. 1, multiple guard beds may be contained in the hydrotreating reactor 28 such as 2, 3 or more and a hydrogen quench from a hydrogen manifold 18 may be injected at interbed locations to control temperature exotherms.

A contacted hydrocarbon stream is discharged from the guard bed 27. In the guard bed 27, most of the hydrodemetallation and hydrodeoxygenation reactions will occur with some hydrodenitrogenation and hydrodesulfurization occurring. Metals removed from biorenewable feedstocks will include alkali metals and alkali earth metals and phosphorous. If the guard bed has a dedicated reactor vessel, the contacted hydrocarbon stream will discharge from the guard bed reactor. However, in FIG. 1, the guard bed 27 is contained in the hydrotreating reactor 28, so the contacted stream will receive a hydrogen quench from hydrogen manifold 18 and enter into a hydrotreating catalyst bed 29.

The biorenewable feed stream is hydrotreated in the hydrotreating reactor 28 to produce a hydrotreated effluent stream. In the hydrotreating reactor 28, the contacted hydrocarbon stream is contacted with a hydrotreating catalyst in the hydrotreating catalyst bed 29 in the presence of hydrogen at hydrotreating conditions to saturate the olefinic or unsaturated portions of the n-paraffinic chains in the biorenewable feedstock. The hydrotreating catalyst also catalyzes hydrodeoxygenation reactions, while minimizing hydrodecarboxylation and hydrodecarbonylation reactions, to remove oxygenate functional groups from the hydrocarbon molecules in the biorenewable feedstock which are converted to water and carbon oxides. The hydrotreating catalyst also catalyzes hydrodenitrogenation of organic nitrogen in the biorenewable feedstock. Essentially, the hydrotreating reaction removes heteroatoms from the hydrocarbons and saturates olefins in the feed stream.

The hydrotreating catalyst may be provided in one, two or more beds and employ interbed hydrogen quench streams from the hydrogen quench stream. Recycle hydrogen quench streams taken from the recycle hydrogen line 19 in a hydrogen manifold line 18 may be provided for interbed quench to the hydrotreating reactor 28. Three hydrotreating catalyst beds 29 are shown in FIG. 1, but more or less than three catalyst beds may be contemplated.

The hydrotreating catalyst may comprise nickel, nickel/molybdenum, or cobalt/molybdenum dispersed on a high surface area support such as alumina. Other catalysts include one or more noble metals dispersed on a high surface area support. Non-limiting examples of noble metals include platinum and/or palladium dispersed on an alumina support such as gamma-alumina. Suitable hydrotreating catalysts include BDO 200 or BDO 300 or BDO 400 available from UOP LLC in Des Plaines, Illinois. The hydrotreating reaction temperature may range from between about 271° C. (520° F.) and about 427° C. (800° F.) and preferably between about 304° C. (580° F.) and about 400° C. (752° F.). Generally, hydrotreating conditions include a pressure of about 700 kPa (100 psig) to about 21 MPa (3000 psig).

A hydrotreated effluent stream is produced in a hydrotreated line 32 from the hydrotreating reactor 28 comprising a hydrocarbon fraction which has a substantial n-paraffin concentration. Oxygenate concentration in the hydrocarbon fraction is essentially nil, whereas the olefin concentration is substantially reduced relative to the contacted biorenewable feed stream. The organic nitrogen concentration in the hydrocarbon fraction may be less than 10 wppm. The hydrotreated stream will have a concentration of nC16 paraffins of about 5 to about 50 wt %.

The hydrotreated effluent stream in the hydrotreated line 32 may first flow to the combined hydroisomerization feed exchanger 34 to heat the hydroisomerization feed stream in the hydroisomerization feed line 44 and cool or partially cool the hydrotreated effluent stream in line 32. As previously described, the cooled or partially cooled hydrotreated effluent stream in the hydrotreated line 11 may then be further heat exchanged with the hydrotreating charge hydrocarbon stream in line 26 in the combined feed heat exchanger 22 to further cool the cooled hydrotreated effluent stream in the hydrotreated line 11 and heat the hydrotreating charge hydrocarbon stream in line 26. The twice cooled hydrotreated effluent steam in the hydrotreated line 19 may be even further cooled in another heat exchanger 17, perhaps to make steam, before it is separated.

The hydrotreated stream in line 19 may be separated to provide a hydrotreated vapor stream and a hydrotreated liquid stream having a smaller oxygen concentration than the biorenewable feed stream.

A desired product, such as a transportation fuel, may be recovered or separated from the hydrotreated stream in line 19. However, the hydrotreated stream in line 19 comprises a higher concentration of normal paraffins, and it will possess poor cold flow properties. The hydrotreated stream in line 19 comprises a liquid portion and a gaseous portion. The liquid portion comprises a hydrocarbon fraction which is essentially all n-paraffins and has a cetane number of about 100. Although this hydrocarbon fraction is useful as a diesel fuel, because it comprises essentially all n-paraffins, it will have poor cold flow properties. If it is desired to improve the cold flow properties of the liquid hydrocarbon fraction, then the hydrotreated effluent stream in line 19 can be contacted with an hydroisomerization catalyst under hydroisomerization conditions to at least partially hydroisomerize the n-paraffins to isoparaffins, as hereinafter described.

Before hydroisomerization, the two-phase hydrotreated effluent stream in line 19 may be passed to a downstream hot separator 36 to separate the cooled hydrotreated stream into a hot separated vapor stream in line 38 and a hot separated liquid stream in line 40. In an embodiment, the hot separator may be an enhanced hot separator (EHS) 36. The hydrotreated effluent stream is separated in the hot separator 36 into a hot separated vapor stream in line 38 and a hot separated liquid stream in line 40. The hydrotreated stream in line 19 may be passed to the EHS 36 through a first inlet 13 of the EHS. The EHS 36 is a high-pressure stripping column. The function of the EHS is to strip a certain amount of light material out of the liquid phase reactor effluent stream. The EHS typically combines gross separation of recycle vapor from liquid within a packed or trayed stripping column that achieves additional vapor stripping. The liquid phase flows down through the column where it is partially stripped of CO, CO2, H2S and H2O, which are potential hydroisomerization catalyst poisons. A stripping gas such as hydrogen in line 39 is passed to the EHS 36.

The cooled hydrotreated stream may be separated in the EHS 36 with the aid of a stripping gas such as hydrogen fed in the stripping line 39. The hydrotreated stream in line 19 is separated to provide a hot separated vapor stream in a hot separated vapor stream in line 38 and a hot separated liquid stream in a hydrotreated bottoms line 40 having a smaller oxygen concentration than the hydrotreating charge hydrocarbon stream in line 26. In the EHS 36, the hydrotreated effluent stream from the hydrotreated line 32 flows down through the column where it is partially stripped of hydrogen, carbon dioxide, carbon monoxide, water vapor, propane, hydrogen sulfide, and phosphine, which are potential hydroisomerization catalyst poisons, by contact with stripping gas from the stripping line 39. The stripping gas may comprise a portion in line 51 of the makeup hydrogen gas stream in line 41 as hereinafter described.

The stripping gas in the stripping line 39 enters the hydrotreating separator 36 at an inlet 37 below the inlet 13 for the hydrotreated effluent stream in the hydrotreated line 19. The hydrotreating separator 36 may include internals such as trays or packing located between the inlet 13 for the hydrotreated effluent stream in line 19 and the inlet 37 for the stripping gas in the stripping line 39 to facilitate stripping of the hydrotreated stream.

The hydrotreating separator 36 operates at about 177° C. (350° F.) to about 371° C. (700° F.) and preferably operates at about 232° C. (450° F.) to about 315° C. (600° F.). The hydrotreating separator 36 may be operated at a slightly lower pressure than the hydrotreating reactor 28 accounting for pressure drop through intervening equipment. The hydrotreating separator 36 may be operated at pressures between about 3.4 MPa (gauge) (493 psig) and about 20.4 MPa (gauge) (2959 psig). The hot separated vapor stream in the hydrotreating separator overhead line 38 may have a temperature of the operating temperature of the hydrotreating separator 36.

The hydrotreated liquid stream which may have been stripped collects in the bottom of the hydrotreating separator 36 and flows in a hot separated liquid stream in a hydrotreated bottoms line 40. The liquid hydrotreated stream comprises diesel range material, with a high paraffinic concentration if the hydrocarbon feed comprises a biorenewable feedstock. The liquid hydrotreated stream in the hydrotreating separator bottoms line 40 may be split into two streams: a hydroisomerization feed stream taken in a hydroisomerization charge line 42 and the recycle hydrotreated stream taken in the recycle line 16 both taken from the liquid hydrotreated stream in the hydrotreated bottoms line 40. The recycle hydrotreated stream in the recycle line 16 may be pumped and combined with the combined hydrocarbon stream in line 24 as previously described.

While a desired product, such as a transportation fuel, may be provided in the hydrotreated bottoms line 40 because the liquid hydrotreated stream comprises a higher concentration of normal paraffins, it will possess poor cold flow properties and high FBP disqualifying it from meeting jet fuel specifications. Accordingly, to improve the cold flow properties and reduce FBP, the hydrotreated liquid stream may be hydroisomerized. A hydroisomerization feed stream may be taken from the hot separated liquid stream in line 40 and hydroisomerized in an hydroisomerization reactor in the presence of hydrogen over a hydroisomerization catalyst to provide a hydroisomerized stream

Make-up hydrogen gas in make-up line 55 may be compressed in a make-up gas compressor 45 to provide compressed make up gas in a compressed make-up gas header 47. A hydroisomerization make-up gas stream is taken from the make-up gas header 47 and mixed with the hydroisomerization feed stream in line 42 taken from the hot separated liquid stream in line 40 to provide a combined hydroisomerization charge stream in the combined hydroisomerization charge line 44. Optionally, a portion of the compressed make-up gas stream in line 47 may be taken in line 51 and passed to the hydrotreating separator 36 in the stripping gas line 39. In an aspect, greater than 99 wt % of n-C16 hydrocarbons in the hydrotreated effluent stream is hydroisomerized in the hydroisomerization reactor 48.

The combined hydroisomerization charge stream in the combined hydroisomerization charge line 44 may be heated in an hydroisomerization feed exchanger 34 by heat exchange with the hydrotreated effluent stream in the hydrotreated line 32. The combined hydroisomerization charge stream may be heated in a hydroisomerization charge heater 46 to bring the combined hydroisomerization charge stream to hydroisomerization temperature before charging the combined hydroisomerization charge stream in a heated hydroisomerization charge line 49 to the hydroisomerization reactor 48. In an embodiment, nC16 hydrocarbons in a return stream taken from the hot separated vapor stream is also hydroisomerized in the hydroisomerization reactor. In an exemplary embodiment, the hydroisomerization charge stream in line 44 may comprise normal C16 hydrocarbons in a range of at least about 60 wt % of total C16 hydrocarbons in the biorenewable feed stream in line 12.

Hydroisomerization, including hydrodewaxing, of the normal hydrocarbons in the hydroisomerization reactor 48 can be accomplished over one or more beds of hydroisomerization catalyst, and the hydroisomerization reaction may be operated in a co-current mode of operation. Fixed bed, trickle bed down-flow or fixed bed liquid filled up-flow modes are both suitable.

The hydroisomerization catalyst comprises a dehydrogenation metal, a molecular sieve and a metal oxide binder. The hydroisomerization catalyst may comprise a dehydrogenation metal comprising a Group VIII metal. The dehydrogenation metal(s) may be selected from platinum, palladium, nickel, nickel molybdenum sulfide or nickel tungsten sulfide. Preferably, the dehydrogenation metal is selected from platinum or nickel tungsten sulfide. The concentration of dehydrogenation metal on the hydroisomerization catalyst may comprise from 0.05 to 5 wt % based on the transition metal(s).

The dehydrogenation metal is distributed between the molecular sieve and the binder with about 40 to about 65 wt %, preferably 45 to about 60 wt %, of the metals distributed on the molecular sieve and about 40 to about 65 wt %, preferably 45 to about 60 wt %, of the metals distributed on the binder. The associated benefit of the hydroisomerization catalyst is high activity and selectivity toward hydroisomerization. In a further embodiment the hydroisomerization catalyst further comprises less than about 0.5 wt % carbon with the associated benefit of high activity and selectivity towards hydroisomerization.

In an embodiment, the hydroisomerization catalyst comprises one or more molecular sieves having a topology selected from AEI, AEL, AFO, AFX, ATO, BEA, CHA, FAU, FER, MEL, MFI, MOR, MRE, MTT, MWW or TON, such as EU-2, ZSM-11, ZSM-22, ZSM-23, ZSM-48, SAPO-5, SAPO-11, SAPO-31, SAPO-34, SAPO-41, SSZ-13, SSZ-16, SSZ-39, MCM-22, zeolite Y, ferrierite, mordenite, ZSM-5 or zeolite beta, with the associated benefit of the molecular sieve being active in the hydroisomerization of linear hydrocarbons.

The metal oxide binder may be taken from the group comprising alumina, silica, silica-alumina and titania or mixtures thereof. Preferably the metal oxide binder is alumina and preferably it is gamma alumina.

The hydroisomerization catalyst may comprise a molecular sieve having an AEL topology and more specifically it may be SAPO-11. Most of the acid sites on SAPO-11 are weak to moderate acid sites. More specifically, at least 50% of the total acidity on the SAPO-11 is weak acidity and at least 60-80% of the external acidity on SAPO-11 is weak acidity.

The hydroisomerization catalyst typically comprises particles having a diameter of about 1 to about 5 millimeters. The catalyst production typically involves the formation of a stable, porous support, followed by impregnation of active metals. The stable, porous support typically comprises a metal oxide as well as a molecular sieve, which may be a zeolite. The stable support is produced with a high porosity, to ensure maximum surface area, and it is typically desired to disperse the active metal over the full internal and external surface area of the support. DI-200 available from UOP LLC in Des Plaines, Illinois may be a suitable hydroisomerization catalyst.

Hydroisomerization conditions generally include a temperature of about 150° C. (302° F.) to about 450° C. (842° F.) and a pressure of about 1724 kPa (abs) (250 psia) to about 13.8 MPa (abs) (2000 psia). In another embodiment, the hydroisomerization conditions include a temperature of about 300° C. (572° F.) to about 388° C. (730° F.), a pressure of about 3102 kPa (abs) (450 psia) to about 13790 kPa (abs) (2000 psia), a LHSV of about 0.5 to 3 hr⁻¹ and a hydrogen rate of about 337 Nm³/m³ (2,000 scf/bbl) to about 2,527 Nm³/m³ oil (15,000 scf/bbl).

A hydroisomerized stream in a hydroisomerized line 50 from the hydroisomerization reactor 48 is a branched-paraffin-rich stream. Preferably the hydroisomerized stream is predominantly a branched paraffin stream. It is envisioned that the hydroisomerized effluent may contain 80, 90 or 95 mass-% branched paraffins of the total paraffin content. Hydroisomerization conditions in the hydroisomerization reactor 48 are selected to avoid undesirable cracking, so the predominant product in the hydroisomerized stream in the hydroisomerized line 50 is a branched paraffin. By avoiding undesirable cracking, the hydroisomerized stream in the hydroisomerized line 50 will have near and only slightly less of the same composition with regard to carbon numbers as the hydroisomerization feed stream in the hydroisomerization charge line 42. The optimal amount of remaining normal paraffins in line 50 is dependent on the selectivity of the hydroisomerization catalysts but might typically be between 1-7 wt %. The hydroisomerized stream in the hydroisomerized line 50 may be passed to the cold separator and processed as described hereinafter in detail.

We have discovered that renewable jet fuel production may exhibit higher carryover of nC16 hydrocarbons in the hot separated vapor stream in line 38. The carryover of the nC16 hydrocarbons results in these hydrocarbons bypassing the hydroisomerization reactor 48. The bypassing of the of the nC16 hydrocarbons in turn affects the final jet fuel freeze point because these hydrocarbons will have avoided further branching that results from hydroisomerization and will consequently possess poor cold flow properties. Thus, the carryover of the nC16 hydrocarbons in the hot separated vapor stream in line 38 will produce a jet fuel that does not meet the freeze point specification. Also, in case of lighter feed stocks, a higher carryover of nC16 was observed resulting in higher SAF freeze point.

To reduce or limit the nC16 hydrocarbon carryover, the disclosed process and apparatus comprise a second separator to separate a return stream comprising nC16 hydrocarbons and hydroisomerizing nC16 hydrocarbons in the return stream. In the embodiment of FIG. 1, the second separator is a warm separator 57. The warm separator 57 can knockdown nC16 hydrocarbons from the hot separated vapor stream in line 38 into a liquid stream. The knockdown nC16 hydrocarbons are recycled to the hot separator 36. This way a greater proportion of nC16 is passed to the hydroisomerization reactor 48. The produced jet fuel meets the freeze point specification of −47° C. (−53° F.) from this process. Also, the warm separator 57 has the additional benefit of reducing capital expense significantly because the condenser air cooler 64 may be made from a less expensive steel instead of a more expensive alloy. Additionally, by use of the warm separator 57, the size of product condenser air cooler 64 for the cold separator 62 can be reduced by about 30%, suitably by about 40%. Because greater proportion of nC16 is passed to the hydroisomerization reactor 48 and less nC16 is carried over, the condenser air cooler 64 can be reduced in size by at least 30%, suitably at least 40%, relative to the conventional process. Both of these reductions will be explained hereinafter.

Referring back to FIG. 1, the hot separated vapor stream in line 38 may be passed to a warm separator 57. In an exemplary embodiment, the hot separated vapor stream in line 38 may be mixed with a second wash water stream in line 152 to provide a second mixed separated stream in line 153 before it is separated in the warm separator 140. The second mixed separated stream in line 153 is passed to the warm separator 140. In an aspect, the second mixed separated stream in line 153 may be passed perhaps through a heat exchanger 135 to provide a second heat exchanged mixed stream in line 154. The second heat exchanged mixed stream in line 154 may be passed to the warm separator 57.

In accordance with the present disclosure, the warm separator 57 may be operated at a temperature between about 121° C. (250° F.) and about 316° C. (600° F.) preferably be operated between about 149° C. (300° F.) and about 260° C. (500° F.). The pressure of the warm separator 57 is just below the pressure of the hydrotreating reactor 28 accounting for pressure drop.

The warm separator separates the hot separated vapor stream in line 38 into a second separated vapor stream in line 59 and a second separated liquid stream in line 67. Water is also removed from the boot in line 161. The second separated liquid stream in line 164 is returned to the hot separator 36. The second separated liquid stream in line 164 may be passed perhaps through a pump and recycled to the hot separator 36. In an aspect, the pumped second separated liquid stream in line 164 may be passed through a heat exchanger 77 to cool it before returning it to the hot separator 36 in line 168. In an aspect of the present disclosure, the second separated liquid stream in line 164 is passed to the hot separator 36 independently of the hydrotreated stream in line 19. In an exemplary embodiment, the second separated liquid stream in line 164 may be passed to the hot separator 36 through a second inlet 113 of the hydrotreating separator 36. The second inlet 113 may be below the inlet 13 for the hydrotreated stream in line 19. In another exemplary embodiment, the return stream may be the second separated liquid stream in line 164. Normal C16 hydrocarbons in the return stream may be taken in lines 168, 40, 42, 44 and 43 to the hydroisomerization charge stream in line 49 to be hydroisomerized in the hydroisomerization reactor 48. The second separated liquid stream in line 164 is separated with the hydrotreated effluent stream in the hot separator 36 to provide the hot separated liquid stream in line 40 from which the hydroisomerization feed stream in line 42 is taken.

Referring back to the warm separator 57, the second separated vapor stream in line 59 is further separated in a cold separator 62. In an aspect, the second separated vapor stream in line 59 is passed through a condenser 64 before passing it cooler to the cold separator 150. In an embodiment, the second separated vapor stream in line 59 is mixed with a first wash water stream in line 151 to provide a first mixed separated stream in line 61 before it is separated in the cold separator 62. The first mixed separated stream in line 61 is passed to the cold separator 62. In an aspect, the first mixed separated stream in line 61 is passed through a condenser air cooler 64 to condense at least a portion of the second separated vapor stream in line 59. A first condensed mixed stream in line 66 is taken from the condenser air cooler 64 and passed to the cold separator 62. The condenser air cooler 64 may be smaller because the warm separator 57 returns the second separator liquid stream back to the hot separator 36. Additionally, because acids in the aqueous phase are removed in line 161, the condenser air cooler 64 may be made of lower grade metallurgy.

In accordance with the present disclosure, the hydroisomerized stream in a hydroisomerized line 50 is also passed to the cold separator 62. In an aspect, the first condensed mixed stream in line 66 may be combined with the hydroisomerized stream in line 50 to provide a combined stream in line 153 which is passed to the cold separator 62. A water stream is also separated from a boot of the cold separator in line 63. The water stream in line 63, perhaps passed through a pump and separated into the first wash water stream in line 151 and the second wash water stream in line 152.

In the cold separator 62, vaporous components in the hydroisomerized stream in and the second separated vapor stream will separate and ascend to provide a cold separator vapor stream in a cold overhead line 68 and a cold separator liquid stream in a cold bottoms line 70 and a cold aqueous stream taken in a cold aqueous line 63 from the boot. The cold separator vapor stream in the cold overhead line 68 may be split between a recycle cold overhead stream in line 69 and a net cold vapor stream in a net cold overhead line 72.

In an embodiment, the recycle cold overhead stream in line 69 may be passed to sponge absorber column 71 to provide a purified hydrogen stream for recycling. A lean absorbent stream in a lean absorbent line 53 may be fed into the sponge absorber column 71 through an absorbent inlet. The lean absorbent may comprise a naphtha stream in a lean absorbent line 71. In the sponge absorber column 71, the lean absorbent stream and the recycle cold overhead stream are counter-currently contacted. The sponge absorbent absorbs LPG hydrocarbons from the net stripper gaseous stream into an absorbent rich stream which is withdrawn from the bottoms of the sponge absorber column 71 in line 88. A recycle hydrogen stream is withdrawn from the overhead of the sponge absorber column 71 in line 73.

The sponge absorber column 71 may be operated at a temperature of about 34° C. (93° F.) to about 60° C. (140° F.) and a pressure essentially the same as or lower than the cold separator 62.

The recycle hydrogen stream in line 73 is compressed in a recycle gas compressor 75 to provide a compressed hydrogen stream in line 19. The compressed hydrogen stream in line 19 may be recycled to the hydrotreating reactor 28 in the manifold line 18 for interbed quench and in the hydrotreating hydrogen line 20 to the hydrocarbon stream in the feed line 12.

The net cold vapor stream in the net cold overhead line 72 may be passed through a trayed or packed purge scrubbing column 74 where it is scrubbed by means of a scrubbing liquid such as an aqueous solution fed by scrubbing liquid line 76 to absorb acid gases including hydrogen sulfide and carbon dioxide by extracting them into the aqueous solution. Preferred scrubbing liquids include Selexol™ available from UOP LLC in Des Plaines, Illinois and amines such as alkanolamines including diethanol amine (DEA), monoethanol amine (MEA), methyl diethanol amine (MDEA), diisopropanol amine (DIPA), and diglycol amine (DGA). Other scrubbing liquids can be used in place of or in addition to the preferred amines. The lean scrubbing liquid contacts the cold vapor stream and absorbs acid gas contaminants. The resultant “sweetened” cold vapor stream is taken out from an overhead outlet of the purge scrubbing column 74 in a purge scrubber overhead line 78, and an acid gas rich scrubbing liquid is taken out from the bottoms at a bottom outlet of the purge scrubber column 74 in a purge scrubber bottoms line 80. The spent scrubbing liquid from the bottoms may be regenerated and recycled back to the purge scrubbing column 74 in the scrubbing liquid line 76. The scrubbed hydrogen-rich stream emerges from the purge scrubbing column 74 in the purge scrubber overhead line 78 and may be forwarded to a pressure-swing adsorption unit 82 or other hydrogen recovery plant to produce high purity hydrogen in line 84.

The purge scrubbing column 74 may be operated with a gas inlet temperature between about 38° C. (100° F.) and about 66° C. (150° F.) and an overhead pressure of about 3 MPa (gauge) (435 psig) to about 20 MPa (gauge) (2900 psig). Suitably, the purge scrubbing column 74 may be operated at a temperature of about 40° C. (104° F.) to about 125° C. (257° F.) and a pressure of about 1200 to about 1600 kPa. The temperature of the net cold vapor stream 72 fed to the purge scrubbing column 74 may be between about 20° C. (68° F.) and about 80° C. (176° F.) and the temperature of the scrubbing liquid stream in the scrubbing liquid line 76 may be between about 20° C. (68° F.) and about 70° C. (158° F.).

Liquid hydroisomerized fuel components in the hydroisomerized stream and the second separated vapor stream will exit the cold separator in the cold separator liquid stream in the cold bottoms line 70. The cold separator liquid stream in line 70 comprises diesel and jet boiling range fuels as well as other hydrocarbons such as propane and naphtha.

In an embodiment, the cold separator liquid stream in line 70 may be stripped in a stripping column 100 to remove hydrogen sulfide and other gases. The cold separator liquid stream in line 70 may be heated by heat exchange in a heat exchanger and fed to the stripping column 100.

A stripping media which is an inert gas such as steam from a stripping media line 104 may be used to strip light gases from the cold separator liquid stream in line 70. The stripping column 100 provides an overhead stripping stream of naphtha, LPG, hydrogen, steam and other gases in a stripper overhead line 87 and a stripped stream in a stripped bottoms line 106. The overhead stripping stream in the overhead line 87 may be condensed by cooling and separated in a stripping receiver 95. A stripper overhead line 88 from the receiver 95 may carry a stripper overhead stream to an off-gas scrubber 140. Unstabilized liquid naphtha from the bottoms of the receiver 95 may be split to provide a reflux stream in line 97 to the stripping column 100 and a stripper liquid overhead stream that may be transported in line 96 to a debutanizer column 170 for naphtha and LPG recovery. A sour water stream may be collected from a boot of the overhead receiver 95.

The stripping column 100 may be operated with an overhead pressure of about 0.35 MPa (gauge) (50 psig), preferably no less than about 0.70 MPa (gauge) (100 psig), to no more than about 2.0 MPa (gauge) (290 psig). The temperature in the overhead receiver 95 ranges from about 38° C. (100° F.) to about 66° C. (150° F.) and the pressure is essentially the same as in the overhead of the stripping column 100.

The fractionator liquid hydroisomerized stream in the stripper bottoms line 106 may be fed to the product fractionation column 120. The fractionation bottoms stream in the fractionation bottoms line 124 may comprise diesel boiling range hydrocarbons. A diesel stream in a bottoms line 124 may be taken from a bottom of the product fractionation column 120. The product fractionation column 120 may be reboiled by heat exchange with a suitable hot stream or in a fired heater 121 to provide the necessary heat for the distillation. Alternately, a stripping media which is an inert gas such as steam from a stripping media line may be used to heat the column. A reboil stream is taken in line 128 and passed to the fired heater 121 and returned boiling to the product fractionation column 120 in a reboil line 141. A diesel product stream may be taken in a diesel product line 129 to a diesel pool and may be green diesel. The diesel stream in the distillation bottoms line 124 may be a diesel stream having a T5 of about 230° C. (446° F.) to about 296° C. (590° F.) and a T90 of about 343° C. (650° F.) to about 399° C. (750° F.).

The product fractionation column 120 provides an overhead gaseous stream of naphtha in an overhead line 122. The fractionation overhead stream may be completely condensed in a fractionator condenser 143 and separated from water in a fractionation receiver 130. In an embodiment, an air cooler may be employed as the fractionator condenser 143 to condense the overhead gaseous stream of naphtha in line 122. Unstabilized liquid naphtha from the bottom of the receiver 130 in a fractionator overhead liquid line 132 may combined with a naphtha stream in line 176 while a condensed reflux stream is refluxed to the column in a reflux stream in line 133. A water stream may be collected from a boot of the distillation receiver 130.

A kerosene stream may be taken from the side of the product fractionation column 120 in a side line 134. The kerosene stream taken in the side line 134 may be stripped in a kerosene stripper column 136 to drive off lower boiling materials which are returned back to the product fractionation column 120 at a higher elevation in an overhead kerosene line 135. A stripped bottoms kerosene stream is produced in a bottom kerosene line 137, from which a boil up stream is reboiled and fed back to the kerosene stripper column 136 and a jet fuel product stream is taken in line 138. The jet fuel product stream in line 138 meets jet fuel specifications per ASTM D86 including the freeze point and may be a green jet fuel stream taken from a bottom of the kerosene stripper column 136. The jet fuel stream in line 138 may have no more than 0.2 wt % n-C16 hydrocarbons and preferably no more than 0.1 wt % n-C16 hydrocarbons. Preferably, the jet fuel stream in line 138 has no more than 100 wppm n-C16 hydrocarbons. The jet fuel product stream in line 138 may be cooled and transported to the jet fuel pool.

The cut point in the product fractionation column 120 between the diesel stream in the bottoms line 124 and the jet fuel stream in the side line 134 can be adjusted to ensure that the jet fuel stream has the appropriate composition to meet jet fuel specifications.

Optionally a light diesel stream may be taken in a second side line taken below the kerosene take off in line 134 and stripped in a side diesel stripper that are not shown. The product fractionation column 120 may be operated with a bottoms temperature between about 149° C. (300° F.) and about 288° C. (550° F.), preferably no more than about 260° C. (500° F.), and an overhead pressure of about 0.35 MPa (gauge) (50 psig), preferably no less than about 0.70 MPa (gauge) (100 psig), to no more than about 2.0 MPa (gauge) (290 psig). The temperature in the overhead receiver 130 ranges from about 38° C. (100° F.) to about 66° C. (150° F.) and the pressure is essentially the same as in the overhead of the product fractionation column 120.

The overhead stripping stream of naphtha, LPG, hydrogen, hydrogen sulfide, steam and other gases in the stripper overhead line 88 may be passed through a trayed or packed off-gas scrubbing column 140 where it is scrubbed by means of a scrubbing liquid such as an aqueous solution fed by scrubbing liquid line 142 to remove acid gases including hydrogen sulfide and carbon dioxide by extracting them into the aqueous solution. Preferred scrubbing liquids include Selexol™ available from UOP LLC in Des Plaines, Illinois and amines such as alkanolamines including diethanol amine (DEA), monoethanol amine (MEA), methyl diethanol amine (MDEA), diisopropanol amine (DIPA), and diglycol amine (DGA). Other scrubbing liquids can be used in place of or in addition to the preferred amines. The lean scrubbing liquid contacts the overhead stripping stream and absorbs acid gas contaminants such as hydrogen sulfide and carbon dioxide. The resultant “sweetened” overhead stripping stream is taken out from an overhead outlet of the off-gas scrubbing column 140 in a recycle scrubber overhead line 144, and an acid gas rich scrubbing liquid is taken out from the bottoms at a bottom outlet of the recycle scrubber column 140 in a recycle scrubber bottoms line 146. The spent scrubbing liquid from the bottoms may be regenerated and recycled back to the off-gas scrubbing column 140 in the scrubbing liquid line 142. The scrubbed hydrocarbon-rich stream emerges from the off-gas scrubbing column 140 via the off-gas scrubber overhead line 144 and may be forwarded to the sponge absorber column 160 for hydrocarbon recovery.

The off-gas scrubbing column 140 may be operated with a gas inlet temperature between about 38° C. (100° F.) and about 66° C. (150° F.) and an overhead pressure of about 3 MPa (gauge) (435 psig) to about 20 MPa (gauge) (2900 psig). Suitably, the off-gas scrubbing column 140 may be operated at a temperature of about 40° C. (104° F.) to about 125° C. (257° F.) and a pressure of about 1200 to about 1600 kPa. The temperature of the overhead stripping stream 88 to the off-gas scrubbing column 140 may be between about 20° C. (68° F.) and about 80° C. (176° F.) and the temperature of the scrubbing liquid stream in the scrubbing liquid line 142 may be between about 20° C. (68° F.) and about 70° C. (158° F.).

The sponge absorber column 160 may receive the scrubbed hydrocarbon-rich stream in the off-gas scrubber overhead line 144. A lean absorbent stream in a lean absorbent line 165 may be fed into the sponge absorber column 160 through an absorbent inlet. The lean absorbent may comprise a naphtha stream in a lean absorbent line 165 perhaps from the debutanizer bottoms stream in line 176. In the sponge absorber column 160, the lean absorbent stream and the scrubbed hydrocarbon-rich stream are counter-currently contacted. The sponge absorbent absorbs LPG hydrocarbons from the net stripper gaseous stream into an absorbent rich stream.

The hydrocarbons absorbed by the sponge absorbent include some methane and ethane and most of the LPG, C₃ and C₄, hydrocarbons, and any C₅ and C₆+ light naphtha hydrocarbons in the net stripper gaseous stream. The sponge absorber column 160 operates at a temperature of about 34° C. (93° F.) to about 60° C. (140° F.) and a pressure essentially the same as or lower than the off-gas scrubbing column 140 less frictional losses. A sponge absorption off gas stream depleted of LPG hydrocarbons is withdrawn from a top of the sponge absorber column 160 at an overhead outlet through a sponge absorber overhead line 169. The sponge absorption off gas stream in the sponge absorber overhead line 169 may be transported to a fuel gas header that is not shown for providing fuel gas needs. A rich absorbent stream rich in LPG hydrocarbons is withdrawn in a rich absorber bottoms line 166 from a bottom of the sponge absorber column 160 at a bottoms outlet which may be fed to a debutanizer column 170 via the stripper overhead liquid stream in the stripper receiver bottoms line 96.

In an embodiment, the debutanizer column 170 may fractionate the stripper liquid overhead stream and the rich absorbent stream in a debutanizer feed line 167 into a debutanized bottom stream comprising predominantly C₅₊ hydrocarbons and a debutanizer overhead stream comprising LPG hydrocarbons. The debutanizer overhead stream in a debutanizer overhead line 172 may be fully condensed in the debutanizer receiver 171 with reflux to the debutanizer column 170 and recovery of LPG in a debutanized overhead liquid stream in a debutanizer net receiver bottoms line 174. The debutanized overhead liquid stream in the net receiver bottoms line 174 may be taken as a LPG product stream. In an exemplary embodiment, the debutanizer net receiver bottoms line 174 may be passed to an amine and caustic treatment unit 183 to provide a LPG product stream in line 184.

The debutanized bottoms stream may be withdrawn from a bottom of the debutanizer column 170 in a debutanized bottoms line 175. A reboil stream taken from a debutanized bottoms stream in a debutanizer bottoms line 177 from a bottom of the debutanizer column 170 may be boiled up in the reboil line and sent back to the debutanizer column 170 to provide heat to the column. Alternatively, a hot inert media stream such as steam may be fed to the column 170 to provide heat. A net debutanized bottoms stream in line 176 comprising naphtha may be split between the lean absorbent stream in the lean absorbent line 165 and a product naphtha stream which is cooled and forwarded to a gasoline pool in line 179. In an aspect, the fractionator overhead liquid line 132 may be combined with the naphtha stream in line 176 to provide a net bottoms naphtha stream in line 178. The net bottoms naphtha stream in line 178 may be separated into the lean absorbent line 165 and a product naphtha stream in line 179.

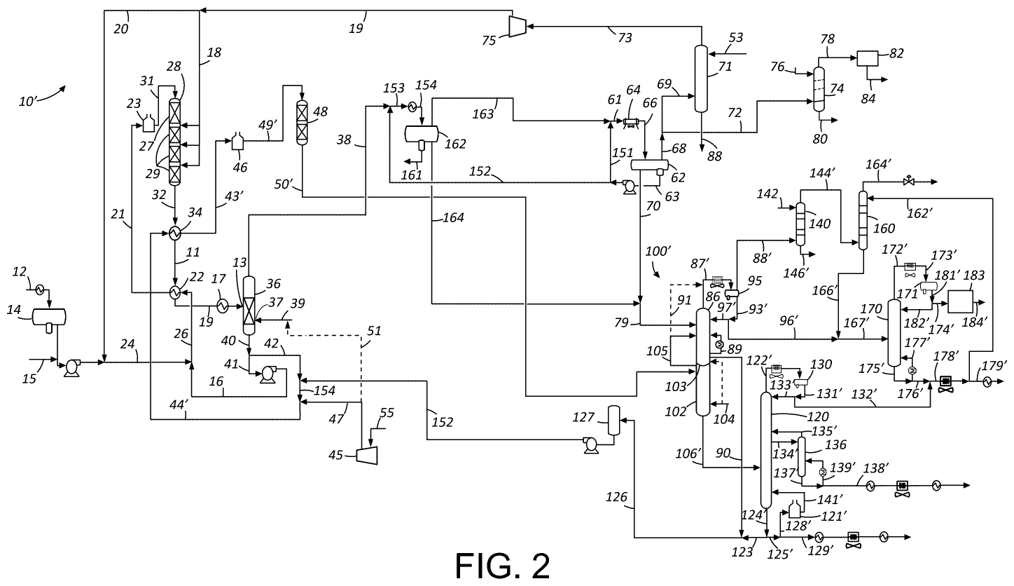

Another exemplary embodiment of the process for producing biofuel from biorenewable feedstock is shown in FIG. 2 in which the warm separator is a second separator but a dual stripping column 100′ is employed to provide a return stream for isomerization in the isomerization reaction 48. Elements in FIG. 2 with the same configuration as in FIG. 1 will have the same reference numeral as in FIG. 1. Elements in FIG. 2 which have a different configuration as the corresponding element in FIG. 1 will have the same reference numeral but designated with a prime symbol (′). The configuration and operation of the embodiment of FIG. 2 is essentially the same as in FIG. 1 with the following exceptions.

In the embodiment shown in FIG. 2, the cold separator liquid stream in the cold bottoms line 70, the hydroisomerized stream in the hydroisomerized line 50, and the second separated liquid stream in line 164 are stripped in a dual stripping column 100′. The cold separator liquid stream in line 70 is stripped with the second separated liquid stream in line 164 to provide a stripped stream.

The dual stripping column comprises a cold stripping column 86 and a hot stripping column 102 which are isolated from each other by an intervening wall 103. In an embodiment, the cold separator liquid stream in line 70 and the second separated liquid stream in line 164 may be stripped in the cold stripping column 86 to remove hydrogen sulfide and other gases. In an exemplary embodiment, the cold separator liquid stream in line 70 and the second separated liquid stream in line 164 may be combined and passed to the cold stripping column 86 in a combined separated stream in line 79. The two streams may be passed separately to the cold stripping column 86.

A reboil stream may be taken from the bottom of the cold stripping column 86, reboiled and passed to the cold stripping column 86 in a reboil line 89 to provide heat to the cold stripping column. Optionally, a stripping media which is an inert gas such as steam from a stripping media line 104 may be used to strip light gases from the combined separated stream in line 79. The cold stripping column 86 provides an overhead stripping stream of naphtha, LPG, hydrogen, steam and other gases in a stripper overhead line 87′ and a cold stripped stream in a cold stripped bottoms line 90. The overhead stripping stream in the overhead line 87 may be condensed by cooling and separated in a stripping receiver 95. A stripper overhead line 88′ from the receiver 95 may carry a stripper overhead stream to an off-gas scrubber 140. Unstabilized liquid naphtha from the bottoms of the receiver 95 in line 93′ may be split to provide a reflux stream in line 97′ to the cold stripping column 86 and a stripper liquid overhead stream that may be transported in a stripper receiver bottoms line 96′ to the debutanizer column 170 for naphtha and LPG recovery perhaps in line 167′ after combination with the rich absorbent stream in line 166′.

The cold stripping column 86 may be operated with an overhead pressure of about 0.35 MPa (gauge) (50 psig), preferably no less than about 0.70 MPa (gauge) (100 psig), to no more than about 2.0 MPa (gauge) (290 psig). The temperature in the overhead receiver 95 ranges from about 38° C. (100° F.) to about 66° C. (150° F.) and the pressure is essentially the same as in the overhead of the cold stripping column 86. It is envisioned that the cold stripping column 86 and the hot stripping column 102 may be two completely separate vessels.

The hydroisomerized stream in the hydroisomerized line 50 is stripped in the hot stripping column 102. In an embodiment, the hot stripping column 102 may be part of the dual-stripping column 100 that comprises the cold stripping column 86 and the hot stripping column 102 which are isolated from each other by an intervening wall 103. A stripping media which is an inert gas such as steam from a hot stripping media line 104 may be used to strip light gases from the hydroisomerized stream in line 50. The hot stripping column 102 provides an overhead stripping stream of naphtha, LPG, hydrogen, steam and other gases in a hot stripper overhead line 105 and a stripped stream in a hot stripped bottoms line 106′. The hot stripper overhead line 105 preferably feeds a hot stripper overhead stream to the cold stripping column 86 to be further stripped of lighter boiling components. Optionally, a portion of the hot stripper overhead stream may be taken in line 91 and passed to the receiver 95 along with the stripper overhead stream in line 87′. The hot stripped stream in the hot stripped bottoms line 106′ is fed to the product fractionation column 120.

The fractionation bottoms stream in the fractionation bottoms line 124′ may comprise diesel boiling range hydrocarbons. A recycle diesel stream in line 123 may be taken from the diesel stream in the bottoms line 124′ from the product fractionation column 120. The recycle diesel stream in line 123 may be reserved in a hydroisomerization charge surge drum 127 and pumped to the hydroisomerization reactor 48. In an exemplary embodiment, the recycle diesel stream in line 123 may be combined with the cold stripped stream in a cold stripped bottoms line 90 to provide a combined bottoms charge stream in line 126 which is passed to the hydroisomerization reactor 48 via the hydroisomerization charge surge drum 127 through lines 152, 154, 44′, and 43′ to the hydroisomerization charge stream in the hydroisomerization charge line 49′. In an exemplary embodiment, the cold stripped stream in the cold stripped bottoms line 90 is the return stream taken from the hot separator vapor stream in line 38.

In the embodiment shown in FIG. 2, a dual stripping column or vessel 100′ is disclosed. The dual stripping column 100′ may comprise an independent reboiled cold stripping column for stripping the hot separated vapor stream from the overhead of the EHS 36. The hot separated vapor stream from the overhead of the EHS 36 is non-isomerized. The non-isomerized hot separated vapor stream is stripped in the cold stripping column 86 to provide a non-isomerized liquid stream in the cold stripped bottoms line 90. The non-isomerized liquid stream including n-C16 hydrocarbons in the cold stripped bottoms line 90 is returned to the hydroisomerization reactor 48 in lines 126, 152, 154, 44′, 43′ and 49′ to be hydroisomerized. The disclosed process shown in FIG. 2 is economical and maximizes routing of the n-C16 hydrocarbons to the hydroisomerization reactor 48 for hydroisomerization.

A pumped bottoms charge stream in line 152 including the recycle diesel stream in line 123 and the cold stripped stream in line 90 which comprises the return stream may be combined with the hydroisomerization feed stream in line 42 to provide a combined hydroisomerization feed stream in line 154. The combined hydroisomerization feed stream in line 154 is mixed with the hydroisomerization make-up gas stream taken from the make-up gas header 47 to provide a combined hydroisomerization charge stream in the combined hydroisomerization charge line 44′. The combined hydroisomerization charge stream in the combined hydroisomerization charge line 44′ is heated in the hydroisomerization feed exchanger 34 by heat exchange with the hydrotreated effluent stream in the hydrotreated line 32. The combined hydroisomerization charge stream may be further heated in the hydroisomerization charge heater 46 before charging the combined hydroisomerization charge stream to the hydroisomerization reactor 48 in a heated hydroisomerization charge line 49′. Carryover nC16 hydrocarbons in the heated hydroisomerization charge line 49′ from the return stream may then be hydroisomerized in the hydroisomerization reactor 48. The rest of the process is the same as previously described in FIG. 1.

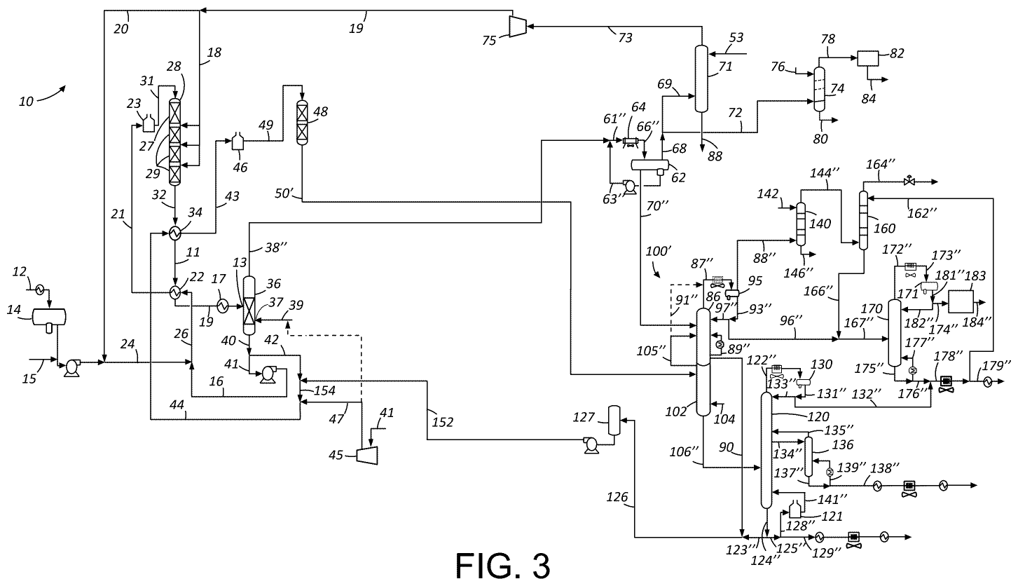

Another exemplary embodiment of the process for producing biofuel from biorenewable feedstock is shown in FIG. 3 in which the dual stripping column 100′ is employed as the second separator. In the exemplary embodiment shown in FIG. 3, the hot separated vapor stream is separated in the cold separator 62 and the warm separator is omitted denominating the cold separator 62 as the second separator. Elements in FIG. 3 with the same configuration as in FIG. 2 will have the same reference numeral as in FIG. 2. Elements in FIG. 3 which have a different configuration as the corresponding element in FIG. 2 will have the same reference numeral but designated with a double prime symbol (″). The configuration and operation of the embodiment of FIG. 3 is essentially the same as in FIG. 2 with the following exceptions.

The hot separated vapor stream in line 38″ is taken from the overhead of the hot separator 36 and passed to the cold separator 62 which is the second separator. The hot separated vapor stream in line 38″ may be combined with a wash water stream in line 63 from the cold separator 62 to provide a first mixed separated stream in line 61″ before it is separated in the cold separator 62. The first mixed separated stream in line 61″ is passed to the cold separator 62 after passing through the condenser air cooler 64. In the cold separator, the hot separated vapor stream in line 38″ is separated into a cold separator vapor stream in a cold overhead line 68″ and a cold separator liquid stream in a cold bottoms line 70″ comprising the second separated liquid stream. A cold aqueous stream is also separated in a cold aqueous line 63″ taken from the boot. In the exemplary embodiment shown in FIG. 3, the cold aqueous stream in line 63″ is mixed with the hot separated vapor stream in line 38″ in its entirety. Alternatively, a portion of the cold aqueous line 63″ may be separated before mixing the cold aqueous line 63″ with the hot separated vapor stream in line 38″. The cold separator liquid stream in a cold bottoms line 70″ is passed to the cold stripping column 86 of the dual-stripping column 100′ to generate the cold stripped stream in line 90 which is the return stream and processed as described previously in FIG. 2. The rest of the process is the same as described for FIG. 2.

Another exemplary embodiment of the process for producing biofuel from biorenewable feedstock is shown in FIG. 4 in which the water stream from the boot of the warm separator 57 is recycled to the warm separator 57 and the cold separator 62. Elements in FIG. 4 with the same configuration as in FIG. 1 will have the same reference numeral as in FIG. 1. Elements in FIG. 4 which have a different configuration as the corresponding element in FIG. 1 will have the same reference numeral but designated with a triple prime symbol (′″). The configuration and operation of the embodiment of FIG. 4 is essentially the same as in FIG. 1 with the following exceptions.

In the embodiment shown in FIG. 4, the water recirculation is shifted from the cold separator 62 to the warm separator 57. The water stream is removed from the boot of the warm separator 57 in line 161. The water stream in line 161 may be separated into a first wash water stream in line 161a and a second wash water stream in line 161b. The first wash water stream in line 161a is combined with the hot separated vapor stream in line 38 to provide a second mixed separated stream in line 153′″. The second mixed separated stream in line 153′″ is passed to the warm separator 57.

The second wash water stream in line 161b may be passed to the cold separator 62. The second wash water stream in line 161b is combined with the second separated vapor stream in line 59 to provide a first mixed separated stream in line 61′″. The first mixed separated stream in line 61′″ is passed to the cold separator 62 and separated therein. The cold aqueous stream is withdrawn in the cold aqueous line 63 from the boot of the cold separator 62. The rest of the process is the same as previously described in FIG. 1.

### Example

A simulation study was conducted to compare the current process with a conventional process without a warm separator. For the current process, a heat exchanger was required upstream of warm separator. Both the conventional process and the current process were conducted at the similar operating conditions and feed rates. The observations of the comparative study are summarized in Table 1 below:

TABLE 1

| | Without Warm | With Warm |
|---|---|---|
| | Separator | Separator |
| | (conventional | (proposed |
| | process) | process) |
| EHS Overhead Exchanger | N/A | 28.7 (8.4) |
| duty, MMBtu/hr (MW) | | |
| Product Condenser Duty, | 70.5 (20.7) | 41 (12.0) |
| MMBtu/hr (MW) | | |
| nC16+ in SAF, wt % | 2.18 | 0.13 |

The warm separator was made of metallurgy of alloy 625. As evident form Table 1, the current process with warm separator provided about 42% reduction in product condenser duty compared to the conventional scheme. Also, a significant reduction in nC16 carryover in SAF product was observed for the current process with warm separator as compared to the conventional scheme. The process with warm separator provided about over 94% reduction in nC16 carryover in SAF product compared to the conventional scheme.

### Specific Embodiments

While the following is described in conjunction with specific embodiments, it will be understood that this description is intended to illustrate and not limit the scope of the preceding description and the appended claims.

A first embodiment of the present disclosure is a process for producing biofuel from biorenewable feedstock, the process comprising hydrotreating a biorenewable feed stream in a hydrotreating reactor to produce a hydrotreated effluent stream; separating the hydrotreated effluent stream in a hot separator into a hot separated vapor stream and a hot separated liquid stream; hydroisomerizing a hydroisomerization feed stream taken from the hot separated liquid stream in an hydroisomerization reactor in the presence of hydrogen over a hydroisomerization catalyst to provide a hydroisomerized stream; and hydroisomerizing a return stream taken from the hot separated vapor stream to the hydroisomerization reactor. An embodiment of the present disclosure is one, any or all of prior embodiments in this paragraph up through the first embodiment in this paragraph further comprising separating the hot separated vapor stream into a second separated vapor stream and a second separated liquid stream and taking the return stream from the second separated liquid stream. An embodiment of the present disclosure is one, any or all of prior embodiments in this paragraph up through the first embodiment in this paragraph wherein the second separated liquid stream is separated with the hydrotreated effluent stream in the hot separator to provide the hot separated liquid stream from which the hydroisomerization feed stream is taken. An embodiment of the present disclosure is one, any or all of prior embodiments in this paragraph up through the first embodiment in this paragraph wherein the hot separated vapor stream is separated in a warm separator to provide the second separated vapor stream and a second separated liquid stream An embodiment of the present disclosure is one, any or all of prior embodiments in this paragraph up through the first embodiment in this paragraph further comprising stripping the second separated liquid stream to provide a stripped stream and providing the return stream from the stripped stream. An embodiment of the present disclosure is one, any or all of prior embodiments in this paragraph up through the first embodiment in this paragraph further comprising separating the second separated vapor stream into a cold separator vapor stream and a cold separator liquid stream and stripping the cold separator liquid stream with the second separated liquid stream to provide the stripped stream. An embodiment of the present disclosure is one, any or all of prior embodiments in this paragraph up through the first embodiment in this paragraph further comprising separating the return stream from a bottom of a cold stripping column. An embodiment of the present disclosure is one, any or all of prior embodiments in this paragraph up through the first embodiment in this paragraph, wherein greater than 99 wt % of n-C16 hydrocarbons in the hydrotreated effluent stream are hydroisomerized in the hydroisomerization reactor. An embodiment of the present disclosure is one, any or all of prior embodiments in this paragraph up through the first embodiment in this paragraph wherein the hydroisomerization feed stream comprises normal C16 hydrocarbons in a range of at least about 60 wt % of total C16 hydrocarbons in the biorenewable feed stream. An embodiment of the present disclosure is one, any or all of prior embodiments in this paragraph up through the first embodiment in this paragraph wherein separating the second separated vapor stream further comprises separating a cold separated water stream from the second separated vapor stream; taking a first wash water stream from the cold separated water stream; and mixing the first wash water stream with the second separated vapor stream before the second separated vapor stream is separated. An embodiment of the present disclosure is one, any or all of prior embodiments in this paragraph up through the first embodiment in this paragraph further comprising taking a second wash water stream from the cold separated water stream; and mixing the second wash water stream with the hot separated vapor stream before the hot separated vapor stream is separated. An embodiment of the present disclosure is one, any or all of prior embodiments in this paragraph up through the first embodiment in this paragraph further comprising fractionating the stripped stream in a fractionation column to provide one or more of a naphtha stream, a diesel stream, and the biofuel stream. An embodiment of the present disclosure is one, any or all of prior embodiments in this paragraph up through the first embodiment in this paragraph, wherein hydrotreating the biorenewable feed stream comprises hydrotreating the biorenewable feed stream in the presence of hydrogen over a hydrotreating catalyst in the hydrotreating reactor to hydrodeoxygenate the biorenewable feed stream and provide the hydrotreated effluent stream. An embodiment of the present disclosure is one, any or all of prior embodiments in this paragraph up through the first embodiment in this paragraph, wherein the hydrotreating reactor is operated at a hydrodeoxygenation selectivity of about 80% to about 99%.

A second embodiment of the present disclosure is a process for producing biofuel from biorenewable feedstock, the process comprising hydrotreating a biorenewable feed stream in the presence of hydrogen over a hydrotreating catalyst in a hydrotreating reactor to hydrodeoxygenate the biorenewable feed stream and provide a hydrotreated effluent stream; separating the hydrotreated effluent stream in a hot separator into a hot separated vapor stream and a hot separated liquid stream; hydroisomerizing a hydroisomerization feed stream taken from the hot separated liquid stream in an hydroisomerization reactor in the presence of hydrogen over a hydroisomerization catalyst to provide a hydroisomerized stream, wherein greater than 99 wt % of n-C16 paraffins in the hydrotreated effluent stream are hydroisomerized in the hydroisomerization reactor; and hydroisomerizing a return stream taken from the hot separated vapor stream. An embodiment of the present disclosure is one, any or all of prior embodiments in this paragraph up through the second embodiment in this paragraph, wherein greater than 99 wt % of n-C16 hydrocarbons in the hydrotreated effluent stream are hydroisomerized in the hydroisomerization reactor.

A third embodiment of the present disclosure is a process for producing biofuel from biorenewable feedstock, the process comprising hydrotreating a biorenewable feed stream in the presence of hydrogen over a hydrotreating catalyst in a hydrotreating reactor to hydrodeoxygenate the biorenewable feed stream and provide a hydrotreated effluent stream, wherein the hydrotreating reactor is operated at a hydrodeoxygenation selectivity of about 80% to about 99%; separating the hydrotreated effluent stream in a hot separator into a hot separated vapor stream and a hot separated liquid stream; hydroisomerizing a hydroisomerization feed stream taken from the hot separated liquid stream in an hydroisomerization reactor in the presence of hydrogen over a hydroisomerization catalyst to provide a hydroisomerized stream, wherein greater than 99 wt % of n-C16 paraffins in the hydrotreated effluent stream are hydroisomerized in the hydroisomerization reactor; and hydroisomerizing a return stream taken from the hot separated vapor stream. An embodiment of the present disclosure is one, any or all of prior embodiments in this paragraph up through the third embodiment in this paragraph further comprising separating the hot separated vapor stream into a second separated vapor stream and a second separated liquid stream and taking the return stream from the second separated liquid stream. An embodiment of the present disclosure is one, any or all of prior embodiments in this paragraph up through the third embodiment in this paragraph wherein the second separated liquid stream is separated with the hydrotreated effluent stream in the hot separator to provide the hot separated liquid stream from which the hydroisomerization feed stream is taken. An embodiment of the present disclosure is one, any or all of prior embodiments in this paragraph up through the third embodiment in this paragraph wherein the second separated liquid stream is passed to a location below the hydrotreated effluent stream in the hot separator.

Without further elaboration, it is believed that using the preceding description that one skilled in the art can utilize the present disclosure to its fullest extent and easily ascertain the essential characteristics of this disclosure, without departing from the spirit and scope thereof, to make various changes and modifications of the present disclosure and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A process for producing biofuel from biorenewable feedstock, the process comprising:
hydrotreating a biorenewable feed stream in a hydrotreating reactor to produce a hydrotreated effluent stream;
separating the hydrotreated effluent stream in a hot separator into a hot separated vapor stream and a hot separated liquid stream;
hydroisomerizing a hydroisomerization feed stream taken from said hot separated liquid stream in an hydroisomerization reactor in the presence of hydrogen over a hydroisomerization catalyst to provide a hydroisomerized stream;
hydroisomerizing hydrocarbons in a return stream taken from the hot separated vapor stream in the hydroisomerization reactor.

2. The process of claim 1 further comprising separating said hot separated vapor stream into a second separated vapor stream and a second separated liquid stream and taking said return stream from said second separated liquid stream.

3. The process of claim 2 wherein said second separated liquid stream is separated with said hydrotreated effluent stream in said hot separator to provide said hot separated liquid stream from which said hydroisomerization feed stream is taken.

4. The process of claim 2 wherein said hot separated vapor stream is separated in a warm separator to provide said second separated vapor stream and a second separated liquid stream.

5. The process of claim 2 further comprising stripping said second separated liquid stream to provide a stripped stream and providing said return stream from said stripped stream.

6. The process of claim 5 further comprising separating said second separated vapor stream into a cold separator vapor stream and a cold separator liquid stream and stripping said cold separator liquid stream with said second separated liquid stream to provide said stripped stream.

7. The process of claim 6 further comprising separating the return stream from a bottom of a cold stripping column.

8. The process of claim 5 wherein said second separated liquid stream is a cold separated liquid stream.

9. The process of claim 1, wherein no less than 99 wt % of n-C16 hydrocarbons in the hydrotreated effluent stream are hydroisomerized in the hydroisomerization reactor.

10. The process of claim 1 wherein the hydroisomerization feed stream comprises normal C16 hydrocarbons in a range of at least about 60 wt % of total C16 hydrocarbons in the biorenewable feed stream.

11. The process of claim 7 wherein separating said second separated vapor stream further comprises:
separating a cold separated water stream from said second separated vapor stream;
taking a first wash water stream from the cold separated water stream;
mixing the first wash water stream with said second separated vapor stream before said second separated vapor stream before it is separated.

12. The process of claim 11 further comprising mixing the second wash water stream with the hot separated vapor stream before it is separated.

13. The process of claim 1, wherein hydrotreating the biorenewable feed stream comprises: hydrotreating the biorenewable feed stream in the presence of hydrogen over a hydrotreating catalyst in the hydrotreating reactor to hydrodeoxygenate the biorenewable feed stream and provide the hydrotreated effluent stream.

14. The process of claim 1, wherein the hydrotreating reactor is operated at a hydrodeoxygenation selectivity of about 80% to about 99%.

15. A process for producing biofuel from biorenewable feedstock, the process comprising:
hydrotreating a biorenewable feed stream in the presence of hydrogen over a hydrotreating catalyst in a hydrotreating reactor to hydrodeoxygenate the biorenewable feed stream and provide a hydrotreated effluent stream;
separating the hydrotreated effluent stream in a hot separator into a hot separated vapor stream and a hot separated liquid stream;
hydroisomerizing a hydroisomerization feed stream taken from said hot separated liquid stream in an hydroisomerization reactor in the presence of hydrogen over a hydroisomerization catalyst to provide a hydroisomerized stream, wherein no less than 99 wt % of n-C16 paraffins in the hydrotreated effluent stream are hydroisomerized in the hydroisomerization reactor; and
hydroisomerizing hydrocarbons in a return stream taken from the hot separated vapor stream.

16. The process of claim 15, wherein no less than 99 wt % of n-C16 hydrocarbons in said hydrotreated effluent stream are hydroisomerized in the hydroisomerization reactor.

17. A process for producing biofuel from biorenewable feedstock, the process comprising:
hydrotreating a biorenewable feed stream in the presence of hydrogen over a hydrotreating catalyst in a hydrotreating reactor to hydrodeoxygenate said biorenewable feed stream and provide a hydrotreated effluent stream, wherein the hydrotreating reactor is operated at a hydrodeoxygenation selectivity of at least about 80% to about 99%;
separating said hydrotreated effluent stream in a hot separator into a hot separated vapor stream and a hot separated liquid stream;
hydroisomerizing a hydroisomerization feed stream taken from said hot separated liquid stream in an hydroisomerization reactor in the presence of hydrogen over a hydroisomerization catalyst to provide a hydroisomerized stream; and
hydroisomerizing hydrocarbons in a return stream taken from the hot separated vapor stream.

18. The process of claim 17 further comprising separating said hot separated vapor stream into a second separated vapor stream and a second separated liquid stream and taking said return stream from said second separated liquid stream.

19. The process of claim 18 wherein said second separated liquid stream is separated with said hydrotreated effluent stream in said hot separator to provide said hot separated liquid stream from which said hydroisomerization feed stream is taken.

20. The process of claim 19 wherein said second separated liquid stream is passed to a location below said hydrotreated effluent stream in said hot separator.
